(19) United States
(12) Patent Application Publication
(10) Pub. No.: US 2005/0179274 A1
(43) Pub. Date: Aug. 18, 2005

(54) Hearing aid battery insertion tool

(76) Inventor: Leland M. Lera, Los Altos, CA (US)

Correspondence Address: BURNS DOANE SWECKER & MATHIS L L P, POST OFFICE BOX 1404, ALEXANDRIA, VA, 22313-1404, US

(21) Appl. No.: 10/778,797

(22) Filed: Feb. 13, 2004

(51) Int. Cl. B25B 9/02

(52) U.S. Cl. 294/99.2

(57) ABSTRACT

A pair of tweezers for inserting hearing aid batteries having first and second opposing tines, with first and second positioning members disposed at the ends of the first and second opposing tines respectively, wherein the first positioning member is dimensioned to receive a curved portion of a hearing aid battery therein, and wherein the second positioning member is dimensioned to abut against a side of the hearing aid battery.

### TECHNICAL FIELD

The present invention relates to mechanical tools for handling small batteries, especially hearing aid batteries.

### BACKGROUND OF THE INVENTION

Hearing aid batteries are much smaller than batteries commonly used in other portable electronic devices. As a result of their small size, it is often difficult to change hearing aid batteries. This problem is especially acute when the person changing the hearing aid batteries is an elderly person with either or both of vision problems or shaky hands. As a result, many elderly persons find hearing aid battery changes to be very inconvenient and time consuming.

Moreover, hearing aids consume considerable amounts of power (as compared to other small electronic devices). As a result, hearing aid batteries require constant replacement. Typically, hearing aid batteries must be replaced as often as once a week. Therefore, hearing aid batteries are typically sold in packs. Such constant re-changing of batteries wastes a considerable amount of time, and may potentially cause damage to the hearing aid, especially if the user is fumbling with the batteries.

There are various standard types of hearing aid batteries. These batteries typically have differently shaped positive and negative ends, so that a user does not inadvertently place the hearing aid battery upside down in the hearing aid. Most commonly, the batteries are generally cylindrical, but have one end that is wider than another. This shape of battery is typically received into a “C-shaped or toilet seat-shaped” arm that is rotated to a position in which it extends away from the hearing aid.

What is instead desired is a simple system for replacing hearing aid batteries that can be easily used by a person with reduced vision or dexterity.

### SUMMARY OF THE INVENTION

The present invention provides in insertion tool for hearing aid batteries. The insertion tool comprises a pair of tweezers with first and second opposing tines. A first positioning member is disposed at an end of the first opposing tine, and a second positioning member is disposed at an end of the second opposing tine. The first positioning member is dimensioned to receive a curved portion of a hearing aid battery therein, and the second positioning member is dimensioned to abut against a side of the hearing aid battery.

In various preferred embodiments, the first positioning member comprises a circular plate with a raised curved portion dimensioned to wrap at least partially around the curved portion of the hearing aid battery; and the second positioning member comprises a box-shaped stop. Preferably, a rear edge of the first positioning member is aligned with a front edge of the second positioning member. As such, the first and second positioning members are offset from one another such that the first and second positioning members do not contact one another when the first and second opposing tines are moved together. Preferably, as well, the opposing tines and first and second positioning members are dimensioned such that the ends of the opposing tines may be squeezed together to a distance of less than the combined thickness of the first and second positioning members. Preferably, the opposing tines are made out of a non-conductive material so as to avoid shorting out the battery.

The resulting structure has the advantages of being able to securely grasp onto the hearing aid battery while holding the battery in a preferred orientation such that the user is prevented from inadvertently inserting the hearing aid battery upside down.

### BRIEF DESCRIPTION OF THE DRAWINGS

FIG. 1 is a side elevation view of a hearing aid battery insertion tool.

FIG. 2 is a bottom plan view of a first positioning member on a first tine of the tool, taken along line 2-2 in FIG. 1.

FIG. 3A is a top plan view of a first embodiment of the second positioning member on a second tine of the tool, taken along line 3-3 in FIG. 1.

FIG. 3B is a top plan view of a second embodiment of the second positioning member.

FIG. 4 is a front elevation view of the hearing aid battery insertion tool.

FIG. 5 is an exploded perspective view of the present invention holding a hearing aid battery for insertion into a hearing aid.

### DETAILED DESCRIPTION OF THE DRAWINGS

The present invention provides a tool configured to insert a hearing aid battery into a hearing aid. As will be shown, advantages of the present battery insertion tool include that fact that it grips onto and securely holds the hearing aid batteries. This is particularly advantageous for elderly users with limited finger strength. In addition, the present invention is preferably dimensioned such that the hearing aid battery can only be held therein in one preferred orientation. As a result, a user is prevented from inadvertently inserting the hearing aid battery upside down into the hearing aid.

The present insertion tool may be dimensioned for use with a particular size of battery as commonly available on the market. For example, hearing aid battery sizes 675, 12, 312 or 10. It is to be understood, however, that the present invention is not limited to use with any particular hearing aid battery size. It is also to be understood, that particular embodiments of the present insertion tool may be used with different sized batteries. It is also to be understood that the present invention is not limited to use solely with hearing aids. Rather, it can be used with any other electronic instrument which requires battery insertion and handling.

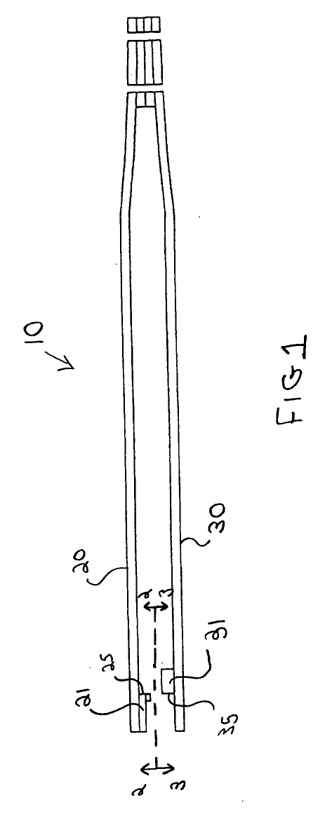

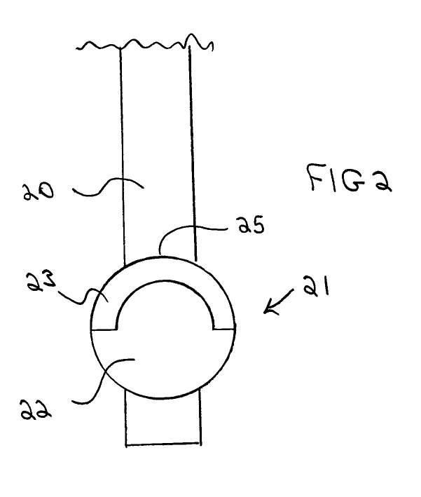

Referring first to FIG. 1, a hearing aid battery insertion tool 10 is provided. Tool 10 includes a pair of tweezers having a first opposing tine 20 and a second opposing tine 30. Tool 10 may be made of any suitable material, including, but not limited to, metal or molded plastic. Preferably, tool 10 (tines 20 and 30) are made from an electrically non-conducting material so as not to short out the battery when the battery is held by tool 10.

A first positioning member 21 is disposed at an end of first opposing tine 20, as shown. A second positioning member 31 is disposed at an end of first opposing tine 30, as also shown.

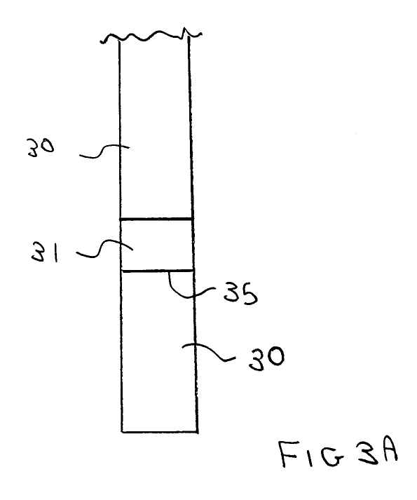

As can be seen in FIG. 2, first positioning member 21 may include a flat plate 22 with a raised curved portion 23. Flat plate 22 may be circular, as shown, but is not so limited. Raised curved portion 23 is preferably dimensioned to receive a curved portion of a hearing aid battery therein. Specifically, as will be shown, raised curved portion 23 is preferably dimensioned to wrap at least partially around the curved portion of a hearing aid battery when plate 22 is positioned against an end of the hearing aid battery. In preferred embodiments, raised curved portion 23 wraps approximately half way around the curved portion of the hearing aid battery when plate 22 is positioned against an end of the hearing aid battery.

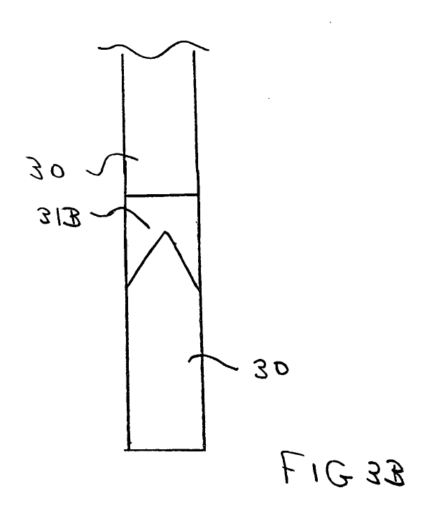

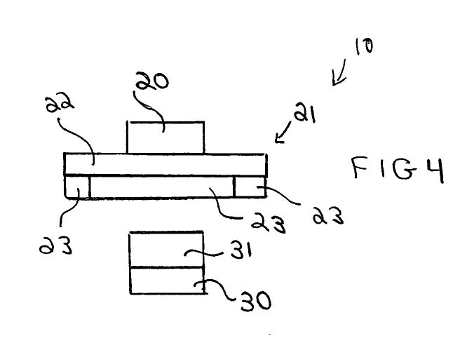

As can be seen in FIG. 3A, second positioning member 31 may simply comprise a stop, which may be rectangular or box-shaped, as shown. Second positioning member 31 is preferably dimensioned to abut against a side of the hearing aid battery. As can be seen in FIG. 3B, second positioning member 31B may instead have a V-shape (with the side of the battery being received within the V-shaped surface). Other designs are also possible, all keeping within the scope of the present invention.

Tines 20 and 30 and their respective positioning members 21 and 31 are dimensioned to operate together to securely grasp onto a hearing aid battery 40, holding it in only one orientation. It is to be understood, however, that positioning members 21 and 31 may be made to dimensions other than those illustrated herein, with their particular dimensions of positioning members 21 and 31 being selected so as to correspond to the particular size of the battery selected.

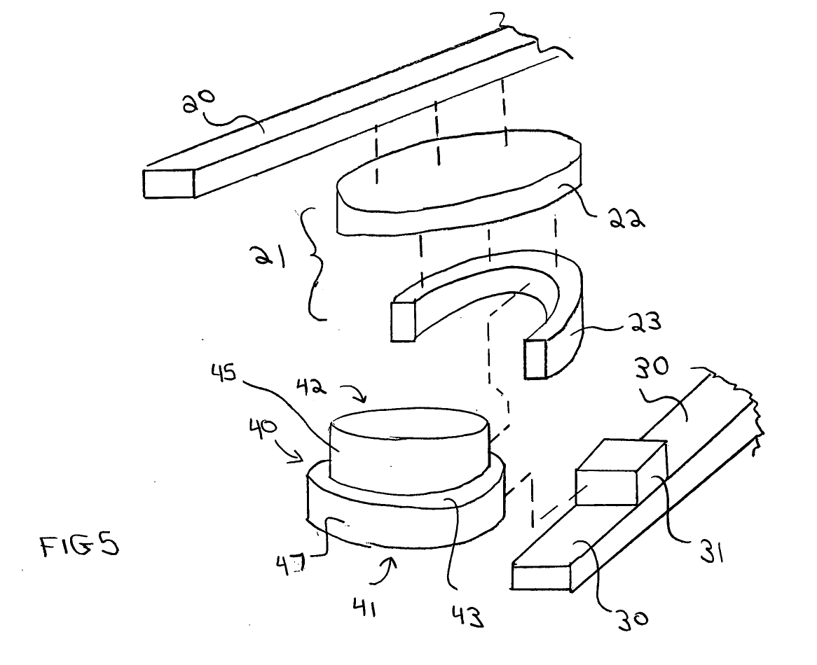

FIG. 4 shows a front elevation view of tool 10 with opposing tines 20 and 30. Raised curved portion 23 of flat plate 22 are shown connected to tine 20 and second positioning member 31 is shown connected to tine 30.

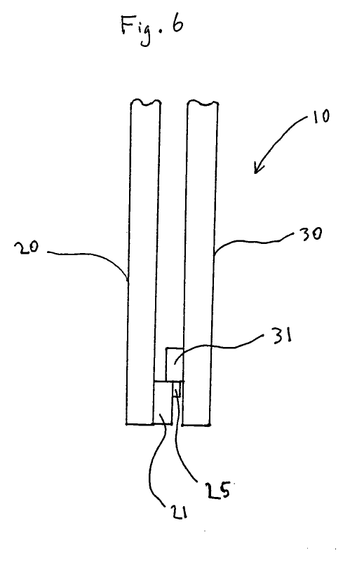

As shown in FIG. 5, hearing aid battery 40 has a generally cylindrical shape, but with its positive end 41 being slightly larger in diameter than its negative end 42. First positioning member 21 on tine 20 is dimensioned such that raised curved portion 23 receives the side 45 of narrower negative end 42 therein, with raised curved portion 23 resting on top of ledge 43 of battery 40. Flat plate 22 rests against end 42 of battery 40. At the same time, wide end 41 of battery 40 is positioned directly on top of tine 30, with the side 47 of wide end 41 resting against positioning member 31.

As can be seen in FIGS. 1 to 3A, a rear edge 25 of first positioning member 21 may preferably be aligned with a front edge 35 of second positioning member 31. As such, first and second positioning members 21 and 31 may be offset from one another on opposing tines 20 and 30 such that first and second positioning members 21 and 31 do not contact one another when opposing tines 20 and 30 are squeezed together. This design is particularly advantageous, in that it allows opposing tines 20 and 30 to be squeezed together until plate 22 contacts battery end 42 and tine 31 contacts battery end 41. Due to this offset between first and second positioning members 21 and 31, the ends of opposing tines 20 and 30 may be squeezed together to a distance of less than the combined thickness of the first and second positioning members 21 and 31.

1. A hearing aid battery insertion tool, comprising:
a pair of tweezers having first and second opposing tines;
a first positioning member disposed between the tines at an end of the first opposing tine; and
a second positioning member disposed between the tines at an end of the second opposing tine, wherein the first positioning member is concavely shaped and is dimensioned to receive a curved portion of a hearing aid battery that is disposed between the tines, and to abut the curved portion of the battery in a first direction, and wherein the second positioning member is dimensioned to abut against a side of the hearing aid battery in the first direction.

2. The tool of claim 1, wherein the first positioning member comprises a plate with a raised concavely shaped curved portion disposed between the tines.

3. The tool of claim 2, wherein the plate is circular.

4. The tool of claim 3, wherein the raised curved portion is dimensioned to wrap at least partially around the curved portion of a hearing aid battery when the plate is positioned against an end of the hearing aid battery.

5. The tool of claim 4, wherein the raised curved portion wraps approximately half way around the curved portion of the hearing aid battery when the plate is positioned against an end of the hearing aid battery.

6. The tool of claim 1, wherein the second positioning member comprises a stop disposed between the tines, the stop having a substantially flat surface for abutting the curved portion of the battery.

7. The tool of claim 1, wherein the stop is box shaped.

8. The tool of claim 1, wherein the stop is V-shaped.

9. The tool of claim 1, wherein a rear edge of the first positioning member is aligned with a front edge of the second positioning member, in a direction perpendicular to the first direction.

10. The tool of claim 1, wherein the first and second positioning members are offset from one another on the first and second opposing tines respectively such that the first and second positioning members do not contact one another when the first and second opposing tines are in a closed position.

11. The tool of claim 1, wherein the opposing tines and first and second positioning members are dimensioned such that the ends of the opposing tines may be squeezed together to a distance of less than the combined thickness of the first and second positioning members.

12. A battery insertion tool, comprising:
a pair of tweezers having first and second opposing tines;
a first positioning member disposed between the tines and at an end of the first opposing tine; and
a second positioning member disposed between the tines and at an end of the second opposing tine, wherein the first positioning member is concavely shaped and is dimensioned to receive a curved portion of a battery that is disposed between the tines, and to abut the curved portion of the battery in a first direction, and wherein the second positioning member is dimensioned to abut against a side of the battery in the first direction.

13. The tool of claim 12, wherein the first positioning member comprises a plate with a raised curved portion, the raised curved portion being disposed between the tines.

14. The tool of claim 13, wherein the plate is circular.

15. The tool of claim 12, wherein the raised curved portion is dimensioned to wrap at least partially around the curved portion of a battery when the plate is positioned against an end of the battery that is disposed between the tines.

16. The tool of claim 12, wherein a rear edge of the first positioning member is aligned with a front edge of the second positioning member, in a direction perpendicular to the first direction.

17. The tool of claim 12, wherein the first and second positioning members are offset from one another in a direction perpendicular to the first direction on the first and second opposing tines respectively such that the first and second positioning members do not contact one another when the first and second opposing tines are in a closed position.

18. The tool of claim 12, wherein the opposing tines and first and second positioning members are dimensioned such that the ends of the opposing tines to which the positioning members are attached may be squeezed together to a distance of less than the combined thickness of the first and second positioning members.
